(19) United States
(12) Patent Application Publication
(10) Pub. No.: US 2003/0097313 A1
(43) Pub. Date: May 22, 2003

(54) System and method for hosting a virtual gallery

(76) Inventors: Barclay Saul, Washington, DC (US); Paul Katz, Falls Church, VA (US); Michael Needle, McLean, VA (US)

Correspondence Address: Finnegan, Henderson, Farabow,, Garrett & Dunner, L.L.P., 1300 I Street, N.W., Washington, DC, 20005-3315, US

(21) Appl. No.: 09/988,215

(22) Filed: Nov. 19, 2001

(51) Int. Cl. G06F 17/60

(52) U.S. Cl. 705/27

(57) ABSTRACT

Methods and systems consistent with the present invention provide for the presentation or exhibition of items, such as for browsing or for e-commerce. In particular, the present invention relates to systems and methods for hosting an on-line art gallery. A method for hosting a virtual art gallery on a network comprising the steps of: providing, on a network, a host system configured with a plurality of gallery accounts including at least a first gallery account, receiving, through the network at the host system, a request for read-only access to the first gallery account by a first user; and providing, on the network to the first user, the first gallery account in a read-only access mode; where each of the plurality of gallery accounts has a gallery item limit, gallery personal information, gallery qualification information, a gallery environment, and at least a first gallery item, and where each of the plurality of gallery accounts is characterized by at least two access modes including the read-only access mode and a qualified access mode; where each of the gallery items is characterized by at least a virtual size; and where the first gallery account in the read-only access mode is configured to allow access to at least two representations of the first gallery item and the gallery environment including a two-dimensional representation and a virtual reality representation.

### I. BACKGROUND OF THE INVENTION

A. Field of the Invention

The present invention relates generally to the field of on-line systems for the presentation or exhibition of items, such as for browsing or for e-commerce. In particular, the present invention relates to systems and methods for hosting an on-line art gallery.

B. Background of the Invention

The growth of the Internet and the subset of the Internet known as the World Wide Web (“the Web”) has enabled many people to engage in online forms of educational and commercial transactions. Two examples of online commercial transactions include a conventional online retail transaction, and a conventional online auction. An example of a conventional online retailer is AMAZON.COM <http://www.amazon.com>, and an example of a conventional online auctioneer is EBAY <http://www.ebay.com>. (See also pp. 296-7 of Startup (1994, Penguin) proposing an electronic auction, later developed by the author J. Kaplan as onsale.com <http://www.onsale.com>). Examples of online educational sites include sites prepared by museums such as the National Gallery of Art in Washington, D.C. <http://www.nga.gov> and the Fine Arts Museums of San Francisco <http://www.famsf.org>. Some features common to these examples are discussed in detail below.

Conventional Online Retailers and Online Auctioneers

Both conventional online retailers and conventional online auctioneers will generally present a web site that includes product search capabilities, as well as a one or a number of formats for product display. For example, a conventional home page associated with an online retailer or an online auctioneer will generally include links to product categories as well as the ability to search for a particular product. The results a search may be presented to a viewer. For example, FIG. 1 depicts a conventional web page of the prior art that may be generated as a result of a search. FIG. 1 includes browser 100 featuring title bar 105 and navigation controls 110. The results of a search may be presented in the form of a web page with a list of abbreviated abstract descriptions of the products correlated with the search criterion, with links to more detailed information (reference numbers 120-124 in FIG. 1), and may also include a thumbnail image or images associated with the product or specials (reference numbers 115-119 in FIG. 1). Upon selecting a link to more detailed information associated with a product, the site may present to the user a product display page that includes more detailed information, as well as perhaps a larger image associated with the item. Here a user may be able to purchase the item using a conventional shopping cart model (See, for example, “Creating the Virtual Store,” John Wiley & Sons (1996) by Magdalena Yesil, which describes the Netscape Merchant System).

A conventional online retailer may limit user interaction to that of engaging in a request for a product based upon availability. The online auctioneer has extended the capabilities of the user browsing the auctioneers web site by allowing the user to post items to the site as well as to request items from the site.

Conventional Online Educational Sites

Educational sites include sites maintained by museums such as the National Gallery of Art in Washington, D.C. <http://www.nga.gov> and the Fine Arts Museums of San Francisco <http://www.famsf.org>. Although some of the features of such web sites may be comparable in certain instances to the commercial online sites, such as the use of search engines, thumbnail images as links to larger images, one of the conventional goals of a museum, which includes the aesthetic presentation of artwork in certain instances adds additional features to the user accessing the site.

For example, one of the features at the National Gallery of Art is the ability to browse a “virtual gallery.” For example, virtual galleries available for online browsing may include artists such as Van Gogh or others. Upon selecting these links, the user views a representation of one of the halls in the National Gallery depicting artwork hanging on the walls using QUICKTIME (available from Apple, Inc.). A user is able to zoom in and out and view information related to the artwork. The artwork and the site, however, are prepared by the National Gallery of Art rather than a user accessing the site.

Likewise, another site is the Fine Arts Museums of San Francisco. The home page of this site provides a link to a page that allows a user to search a database of art (“the THINKER”) and also provides a link to a page where a user can create his or her own virtual gallery. At the web site where users create their own virtual gallery, the users are limited to selecting art from the database of the THINKER, and also limited in the size that the artwork may be presented. Furthermore, the application, based upon SHOCKWAVE (ver. 8) allows anyone to access and create a gallery, but does not allow the user to alter the gallery after it has been created.

An exemplary educational web page is depicted in FIG. 2, for example, using web browser 100 again. The web site may include a specialized type of navigation through the art gallery hall, as, for example, Quicktime, or SHOCKWAVE. Generally, such a site will feature first artwork 216 and second artwork 217 perhaps displayed with different proportions within aesthetic environment 215.

Accordingly, it is desirable for a system and a method that allows a user to create and maintain a virtual art gallery, controlling the content of the gallery, removing or adding pieces for exhibition over time, and that has at least two types of representation including a conventional web page representation and a virtual reality representation.

### II. SUMMARY OF THE INVENTION

Methods and systems consistent with the present invention relate to hosting an on-line art gallery.

In one embodiment of the present invention a method for hosting a virtual art gallery on a network comprises: providing, on a network, a host system configured with a plurality of gallery accounts including at least a first gallery account; receiving, through the network at the host system, a request for read-only access to the first gallery account by a first user; and providing, on the network to the first user, the first gallery account in a read-only access mode; where each of the plurality of gallery accounts has a gallery item limit, gallery personal information, gallery qualification information, a gallery environment, and at least a first gallery item, and where each of the plurality of gallery accounts is characterized by at least two access modes including the read-only access mode and a qualified access mode; where each of the gallery items is characterized by at least a virtual size; and where the first gallery account in the read-only access mode is configured to allow access to at least two representations of the first gallery item and the gallery environment including a two-dimensional representation and a virtual reality representation.

A second embodiment of the present invention comprises the above steps and, in addition, comprises: receiving, on the network at the host system, a request for qualified access to the first gallery account by a second user; and providing, on the network to the second user, the first gallery account in the qualified access mode; where the first gallery account in the qualified access mode is configured to allow the second user to modify the associated gallery personal information, the associated gallery qualification information, to add a second gallery item, and to remove the first gallery item.

### III. BRIEF DESCRIPTION OF THE DRAWINGS

The accompanying drawings, which are incorporated in and constitute a part of this specification, illustrate systems and methods consistent with the invention and, together with the description, serve to explain the advantages and principles of the invention. In the drawings,

FIG. 1 is a depiction of a conventional retailer web site of the prior art incorporating equal-sized images of an item;

FIG. 2 is a depiction of a conventional educational web site of the prior art incorporating a collection of art gallery images;

FIG. 3 depicts a system consistent with the present invention for opening or editing a gallery account;

FIG. 4 depicts a flowchart of a method consistent with the present invention for creating or editing gallery account information;

FIG. 5 depicts an exemplary dialogue box to gather information for creating or editing a gallery account;

FIG. 6 depicts an exemplary dialog box to gather personal information and information for uploading gallery account information;

FIGS. 7-8 depicts an exemplary drag-and-drop interface for editing gallery account information;

FIG. 9 depicts an exemplary option for incorporating artwork into a gallery account;

FIG. 10 depicts an exemplary dialog box to gather information for incorporating artwork of a first size into a gallery account;

FIG. 11 depicts the exemplary drag-and-drop interface for editing gallery account information with artwork of a first size added to the gallery account;

FIG. 12 depicts an exemplary dialog box to gather information for incorporating artwork of a second size into a gallery account;

FIG. 13 depicts the exemplary drag-and-drop interface for editing gallery account information with artwork of a second size added to the gallery account;

FIG. 14 depicts an exemplary option for previewing gallery account information as displayed through a web browser;

FIG. 15 depicts the preview of a gallery account through a web browser with a visual representation of the gallery as well as exemplary links to additional information;

FIG. 16 depicts the preview of a gallery account with a web browser with a VRML visual representation of the gallery as well as an exemplary link to additional information;

FIG. 17 depicts the preview of an additional information associated with the artwork of a second size;

FIG. 18 depicts an exemplary option for uploading gallery account information to the host system;

FIG. 19 depicts an exemplary dialogue box for managing the upload of gallery account information to the host system; and

FIG. 20 depicts a flowchart of a method consistent with the present invention for uploading gallery account information to the host system.

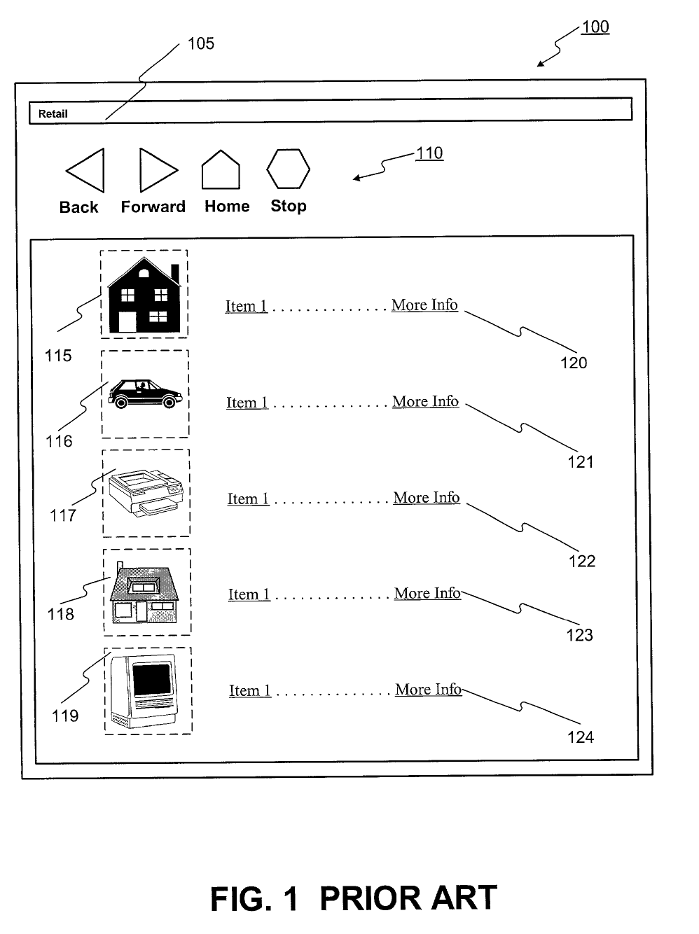

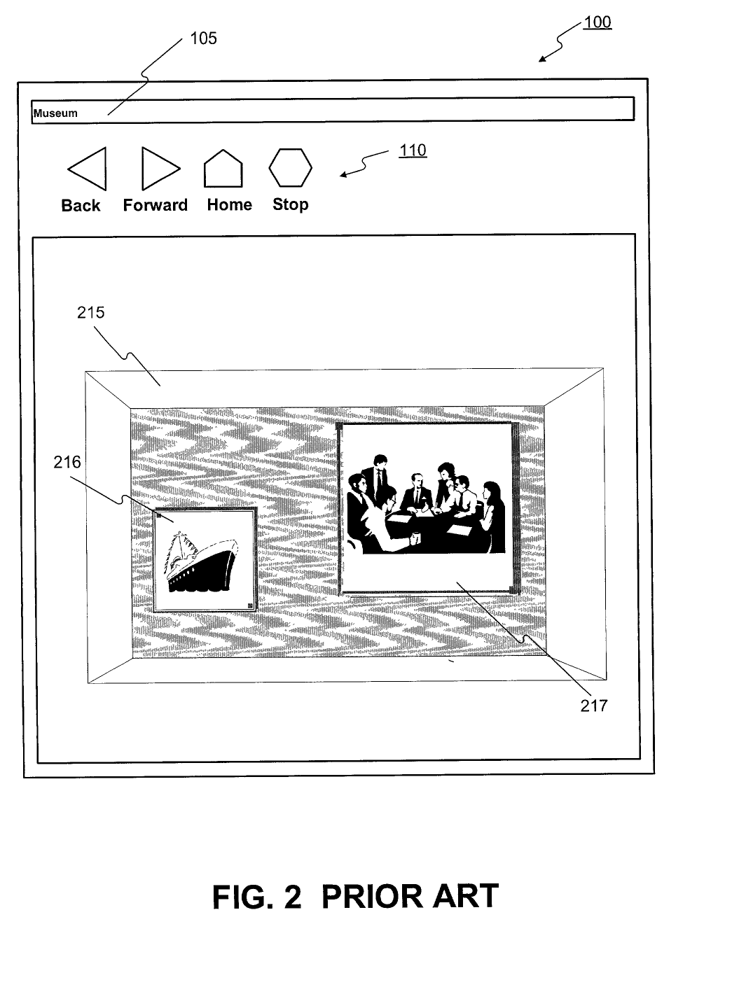

### IV. DETAILED DESCRIPTION

Reference will now be made in detail to an implementation consistent with the present invention as illustrated in the accompanying drawings. Wherever possible, the same reference numbers will be used throughout the drawings and the following description to refer to the same or like parts.

As used herein, “gallery account” refers to a record-keeping arrangement or structure for the purposes of administration and security. Preferably, although it is not necessary, there is a one-to-one relationship between one gallery account of a plurality of gallery accounts and one user of a plurality of gallery account users.

As used herein, a “gallery account user” is an individual that accesses a gallery account according to the gallery account's qualification protocol. For exemplary purposes only, a gallery account user may access a gallery account over a communications network, where the gallery account user transmits and receives data on a local terminal connected, over a communications system, to a host system, which manages the user's gallery account. Qualified gallery account user access, for example, preferably corresponds to conventional author-type access.

As used herein, a “host system” is a structure configured to store and process data associated with a gallery account, configured to allow qualified user access and also configured to allow, for example, conventional reader access over the web to a plurality of viewers. As used herein, a “viewer” is an individual that accesses a web page according to conventional reader-type access.

A. Host System for Maintaining Gallery Accounts

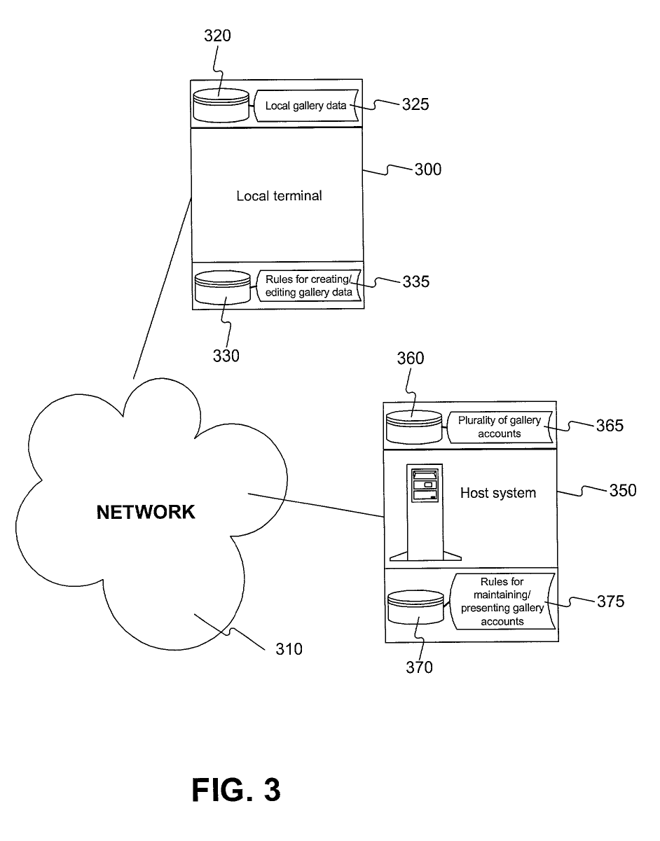

Host systems and local terminals consistent with the present invention allow users to access and edit gallery accounts over a communications network. FIG. 3 depicts a schematic diagram of a system consistent with the present invention. FIG. 3 depicts host system 350, gallery accounts memory 360, gallery accounts information 365, gallery rules memory 370, gallery accounts rules 375, local terminal 300, local gallery memory 320, local gallery information 325, local gallery rules memory 330, local gallery rules 335, and network 310.

Host system 350, in a preferred embodiment, contains the gallery accounts memory 360, which stores the gallery accounts information 365. Gallery accounts information 365 may include: the data associated with a conventional HTML web page; the data associated with an associated VRML page. Other memory associated with host system 350 may include identity information associated with the user of local terminal 300, in order to allow the user author-type access to the appropriate gallery account.

A viewer gains reader-type access to the web page in the conventional manner. For example, a viewer may launch any conventional web browser that supports DHTML (Dynamic Hypertext Markup Language) 4.0 on any type of device capable of browsing the web. Upon accessing the home page, for example, the viewer may be presented with options for accessing a conventional HTML representation of a gallery account, or a VRML version of the gallery account. Other transactions, such as consumer-based transactions may also be enabled. For example, if a viewer wishes to purchase or bid on an item displayed in the gallery account, the viewer simply may be required to access a conventional shopping cart model or auction-based model for communicating with the user and/or completing a transaction.

According to a preferred embodiment, a gallery account user first contacts the administrator of the host system in order to set up a gallery account. Preferably such contact occurs by conventional email, although other forms of contacting an administrator and providing information sufficient to establish a distinguishable identity from a plurality of users is also allowed. The user may also obtain a copy of software available from the gallery. Preferably, such software is similar or equivalent functionally to HANGIT! (available for download from arthangar.org). The software may be configured or written to operate in the web browser environment, such as a program written in JAVA (available from Sun Microsystems, Inc.) or a program written in a server side language with an HTML interface. In addition, the software may be configured to run in the operating environment or system of a conventional PC, microcomputer, workstation, or other exemplary computing device. For exemplary purposes only, we consider a program running in the operating environment or system of a conventional PC. Within some time period after contacting the administrator of the host system (which may also be automated), the user may be contacted by any conventional means and given information necessary to complete an art gallery account. Such information may include, the medium of the artwork to be displayed, the state where the user resides, the skill level of the user, and a user id. The combination of information allows the user of the gallery account to upload data to the gallery account (described further below).

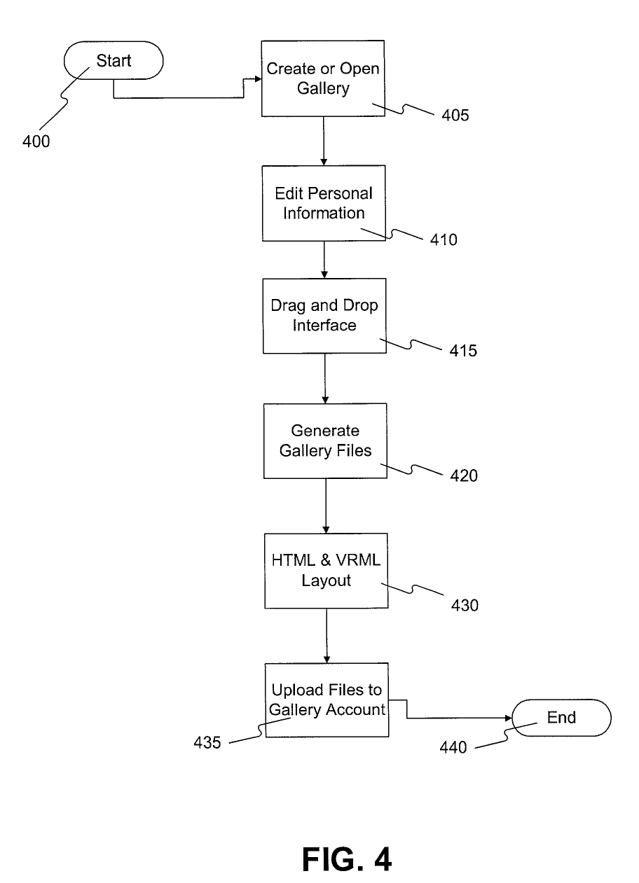

FIG. 4 depicts a general flowchart for a gallery account user to create or update a gallery account. For example, after obtaining the appropriate information from the administrator of host system 350, the gallery account user may initiate a file on local terminal 300 associated with a new gallery account, or may access a file on local terminal 300 associated with an existing gallery account (step 405). If the gallery account user is creating a new gallery account, then the information obtained from the administrator of host system 350 is preferably entered into or associated with the gallery account file during step 410. Otherwise, the gallery account user may edit the information associated with a gallery account preferably through a drag-and-drop interface (step 415). Upon completion of the gallery, including incorporating any artwork of choice into the gallery, then gallery files are generated, which preferably include HTML files and VRML files (step 430). Subsequently, the gallery account user uploads the gallery account files to host system 350 through network 310 (step 435). The host system, then, makes the gallery account available through a conventional web-browsing interface, for example, on the World Wide Web. A detailed description of the steps described above is provided below.

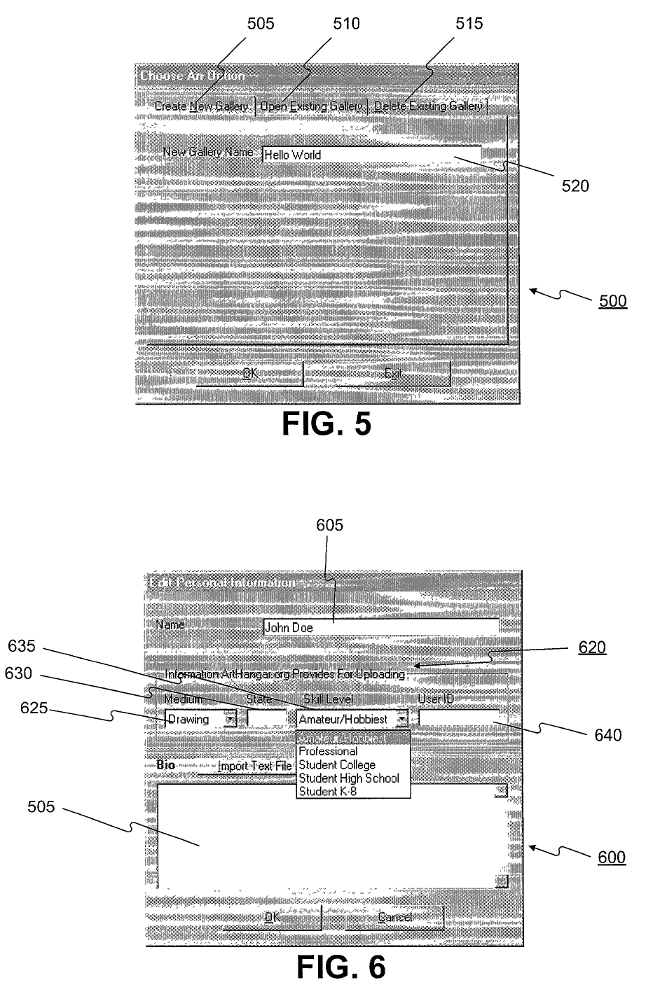

For example, FIG. 5 depicts exemplary dialog box 500 that a gallery account user may be presented with on local terminal 300 upon launching a program such as HANGIT! on local terminal 300. The gallery account user may create a new gallery account (tab 505), open an existing gallery account (tab 510), or delete an existing gallery account (tab 515). In the example depicted in FIG. 5, a new gallery account is created with the name 520 “Hello World.” Upon selecting OK, for example, the user is presented with dialog box 600 (FIG. 6) prompting the user for “personal information.” As above, the gallery account user may enter a name or an alias in name box 605. In the region bounded by label 620 “Information ArtHangar.org Provides for Updating,” the gallery account user enters information as returned from the administrator of host system 350. As stated above, this information may be provided by email to the gallery account user and, for exemplary purposes only, such information may include the medium of the artwork (box 625), the state where the user resides (box 630), the skill level of the user (box 625), and User ID 640 as provided by the administrator of host system 350. Other forms of identification or authentication are also consistent with the present invention. Furthermore, depending upon the medium selected, the skill level, and the state of residence, a user may be conveniently indexed for later lookup on host system 350. Additional biographical details associated with the gallery account user may be provided in box 600, or may be imported from a text file.

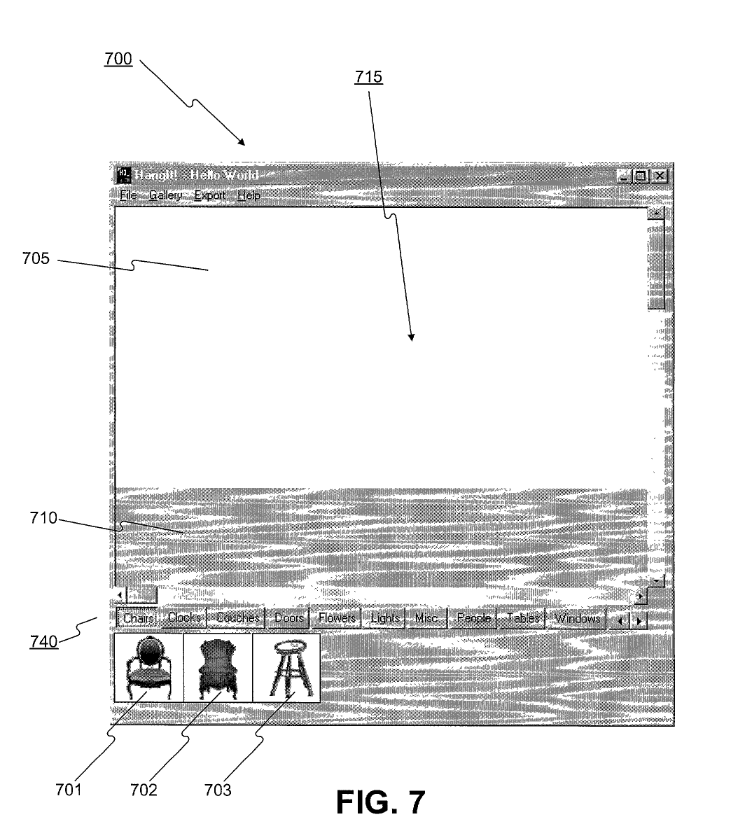

After the gallery account user provides such information, the gallery account user is preferably prompted with drag-and-drop interface 700 (FIG. 7). Drag-and-drop interface 700 includes wall region 705, floor region 710, as well as tabs 740 each associated with one or several props (items 701-703, for example). In FIG. 7, the tab labeled “chair” is selected and a gallery account user preferably double-clicks an item such as item 703, to include the item within the gallery environment 715 including both floor region 710 and wall region 705. Preferably, the gallery account user may drag the floor region 710 to a preferred position within gallery environment 715 to set a visual representation of the height of gallery environment 715. The categories included on tabs 740 may include such categories as: chairs, clocks, couches, doors, flowers, lights, miscellaneous, people, tables, windows, wall textures, and floor textures. As stated above, by first selecting the category tab, the user is presented with a visual representation of an environment item. Double clicking, for example, upon the environmental item introduces it into the gallery account environment 715, partitioned according to wall space, and floor space.

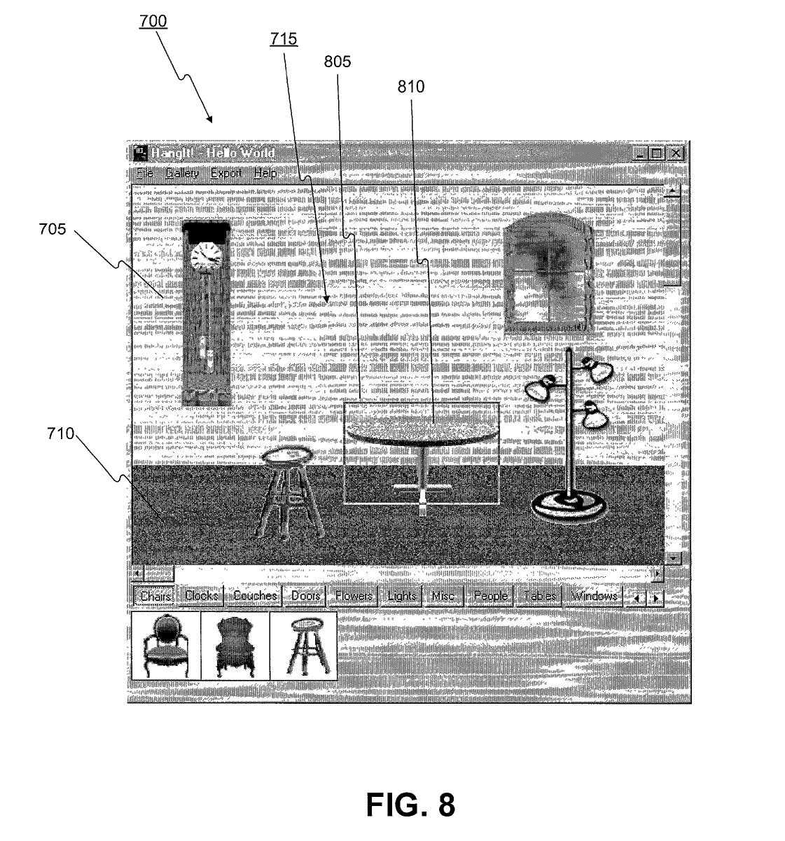

FIG. 8 depicts drag-and-drop interface 700 associated with exemplary gallery account “Hello World” where the wall texture has been set to brick, the floor is textured, and props include a clock, a stool, table 810, and a light. Also depicted in FIG. 8 for exemplary purposes only is drag-and-drop outline 805 associated with table 810. Accordingly, a gallery account user may select an item by depressing a mouse button and then moving the drag-and-drop outline 805 to a new region within gallery environment 715.

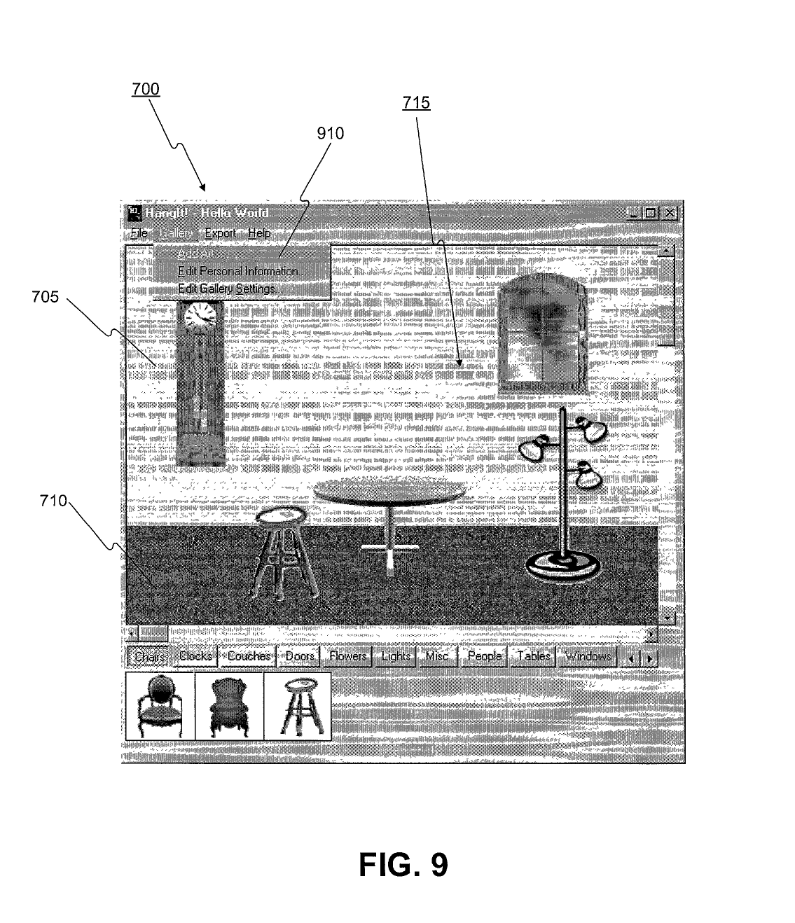

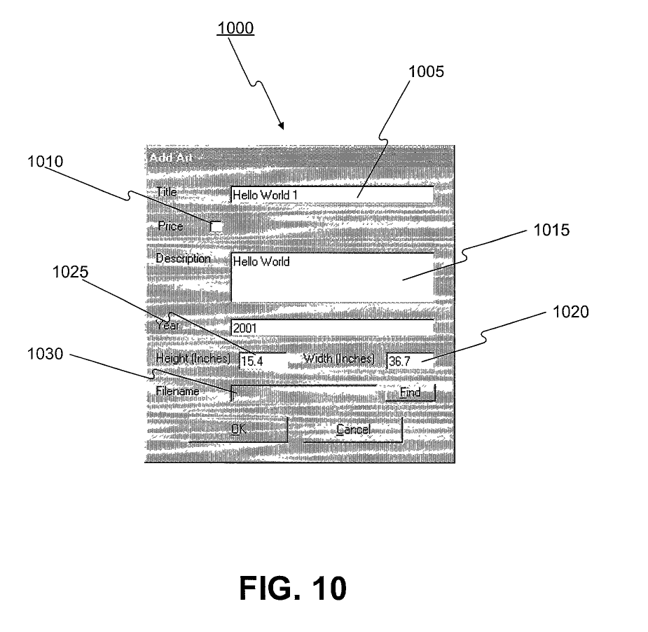

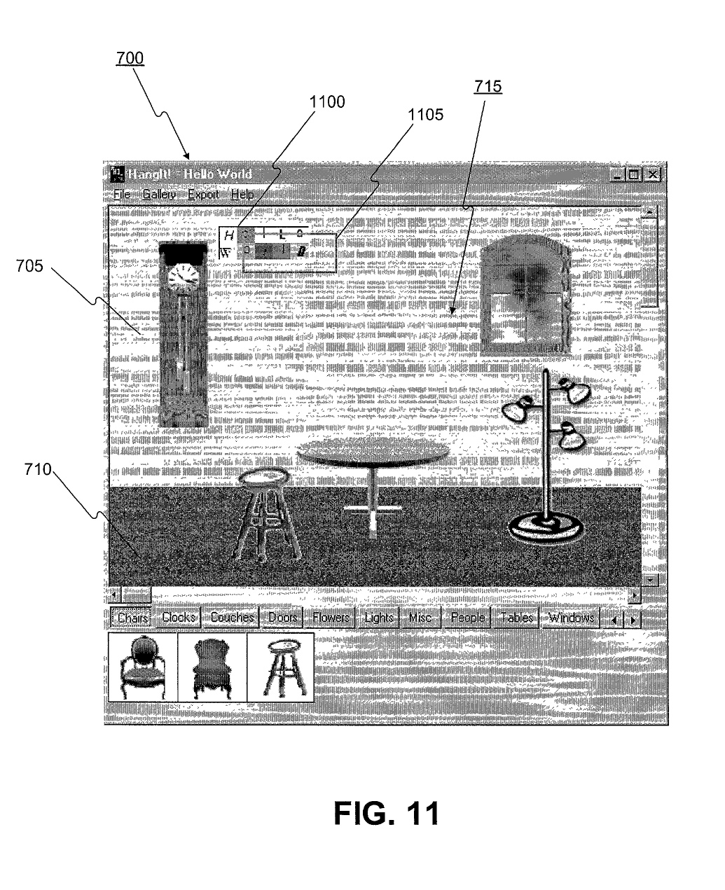

Next, the gallery account user may wish to include artwork. FIG. 9 depicts drag-and-drop interface 700 with menu option 910 allowing the gallery account user to include artwork within gallery environment 715. FIG. 10 depicts an exemplary dialog box 1000 for adding artwork information to a gallery account. For example, the gallery account user may include artwork title information 1005, may check the price checkbox 1010, include artwork description 1015, year information, price information, as well as height information 1025 and width information 1020. In addition, an image file 1030, such as a gif or jpg file, needs to be associated with the artwork. For example, a file located within directory “c:\” and named “hello_world_{—}1.gif.” The account gallery user is preferably presented with a file-browsing option upon selecting a button marked “Find.” Upon selecting “OK,” the user will preferably be returned to drag-and-drop interface 700 in order to position the artwork of a first size 1100 to a particular region of the gallery environment. Again, the gallery account user may be assisted by the user of drag-and-drop outline 1105 in order to position the artwork of a first size 1100.

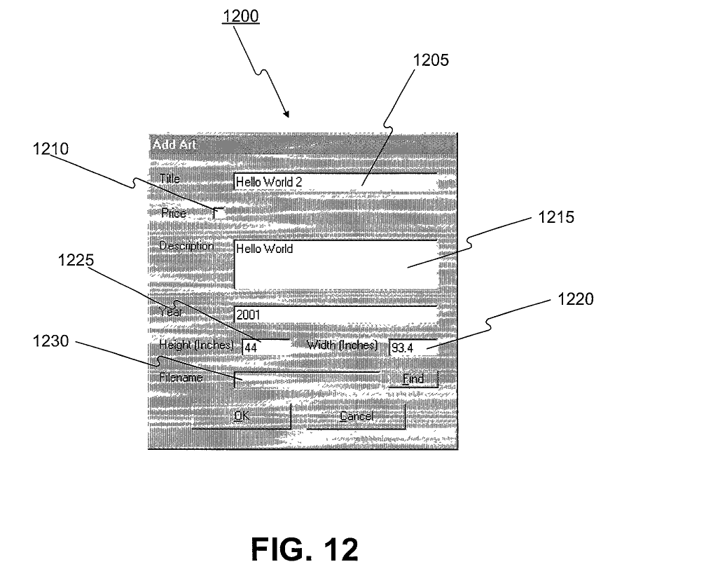

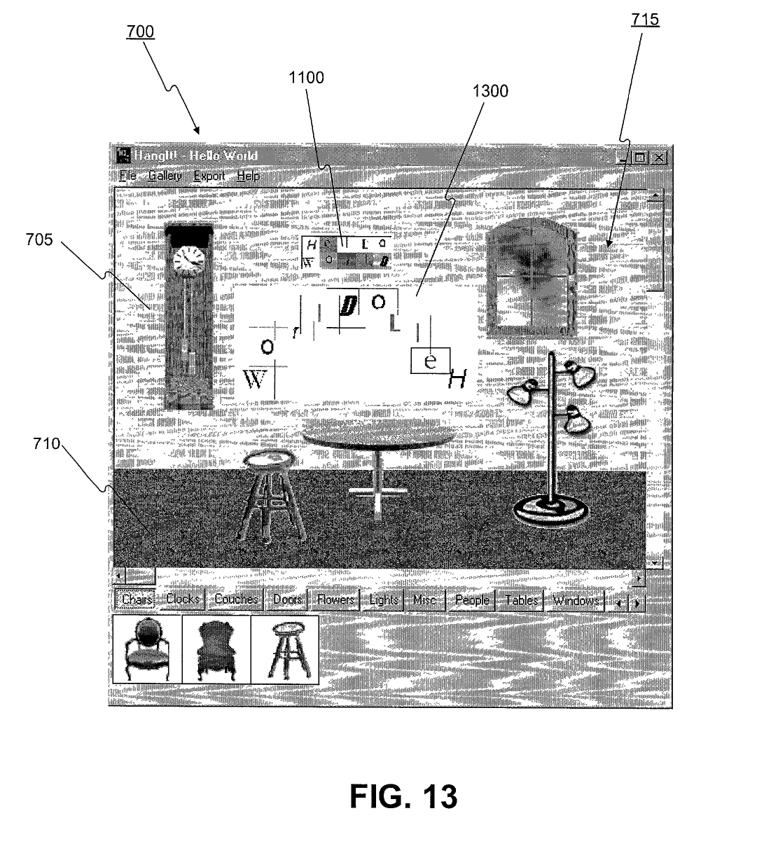

Additional artwork, such as artwork of a second size 1300 may also be added to the gallery environment. FIG. 12 depicts dialog box 1200 similar to dialog box 1000, but with information relating to artwork of a second size 1300. Of particular note are the values for height 1225 and width 1220, which are different from those for artwork of a first size 1100. Again, FIG. 13 depicts drag-and-drop interface 700 with artwork of a second size 1300 positioned within gallery environment and below artwork of a first size 1100.

From the foregoing discussion, one skilled in the art will appreciate that the information associated with the gallery environment, such as, but not limited to, the artist information, the properties of the art in the gallery, and the locations of all the props in the gallery is saved to a gallery environment file for later retrieval and editing through drag and drop interface 700. The gallery environment file may include references to other files, such as prop files and artwork image files.

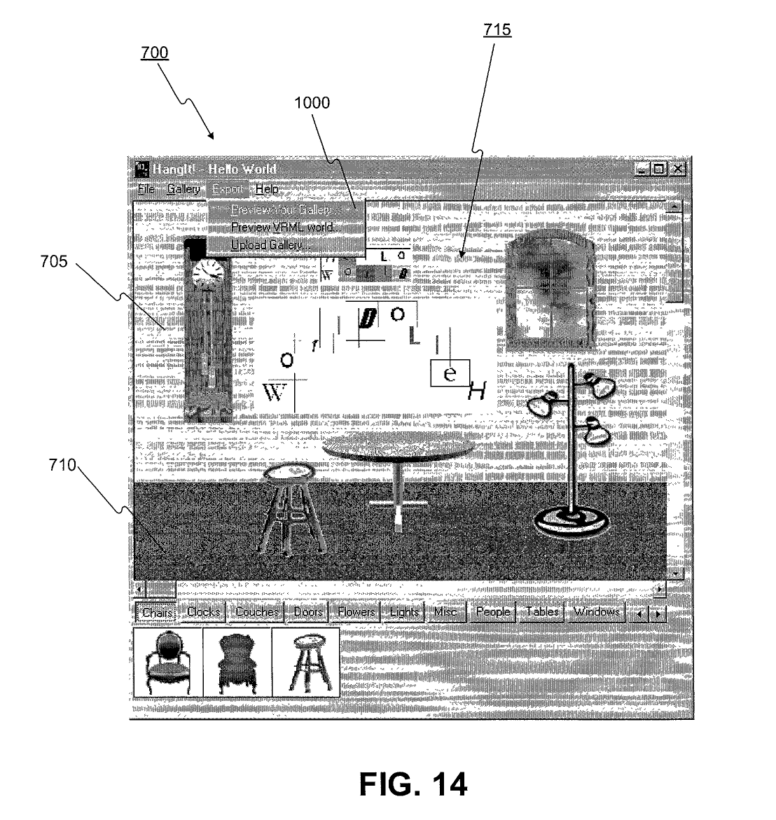

When the gallery account user has changed the gallery account environment to suit their design, then the gallery account user may generate the appropriate HTML and VRML files. FIG. 14 depicts drag-and-drop interface 700 with a menu option 1000 in order to “Preview Your Gallery . . . ” Upon selecting this option, the local terminal 300 according to local gallery account rules 335 will generate the HTML and VRML files for viewing from a directory on local terminal 300. For example, the software will preferably generate a gallery image 1515, which captures the view of gallery environment 715 as set by gallery account user in drag-and-drop interface 700. An HTML page may also include links to the VRML version of the page, a page including additional biographical material associated with the artist whose work may be displayed, as well as embedded links within the gallery account image that will display the artwork as well additional information about the artwork. This is discussed in more detail below.

The steps for converting a gallery environment file into HTML files may include, but is not limited to: using the coordinates of the artwork in the gallery environment file and depicted in the drag and drop interface 700 to position the artwork in the primary HTML file; using the coordinates of the prop items in the gallery environment file and depicted in the drag and drop interface 700 to position the props in the primary HTML file; using the selected wall and floor textures in the gallery environment file and depicted in the drag and drop interface 700 to define the background in the primary HTML file; and creating any additional HTML files that express artwork information and links to such files from the primary HTML file.

The steps for converting a gallery environment file into VRML 2.0 files may include, but is not limited to: defining a wall in 3-D space for associated artwork; defining a floor in the 3-D space that connects to the wall and will be associated with props; creating boxes in 3-D space for each of the pieces of artwork where (i) the height of the box should match the height for the art it is representing, (ii) the width of the box should match the width of the art it is representing, (iii) the depth of the box is preferably very thin, and (iv) the graphic or image file associated with the artwork may be applied to the box as a texture; positioning the box on the wall as defined in the gallery environment file and depicted in drag and drop interface 700; and placing all of the props referenced in the gallery environment file and selected in drag and drop interface 700 in the 3-D scene.

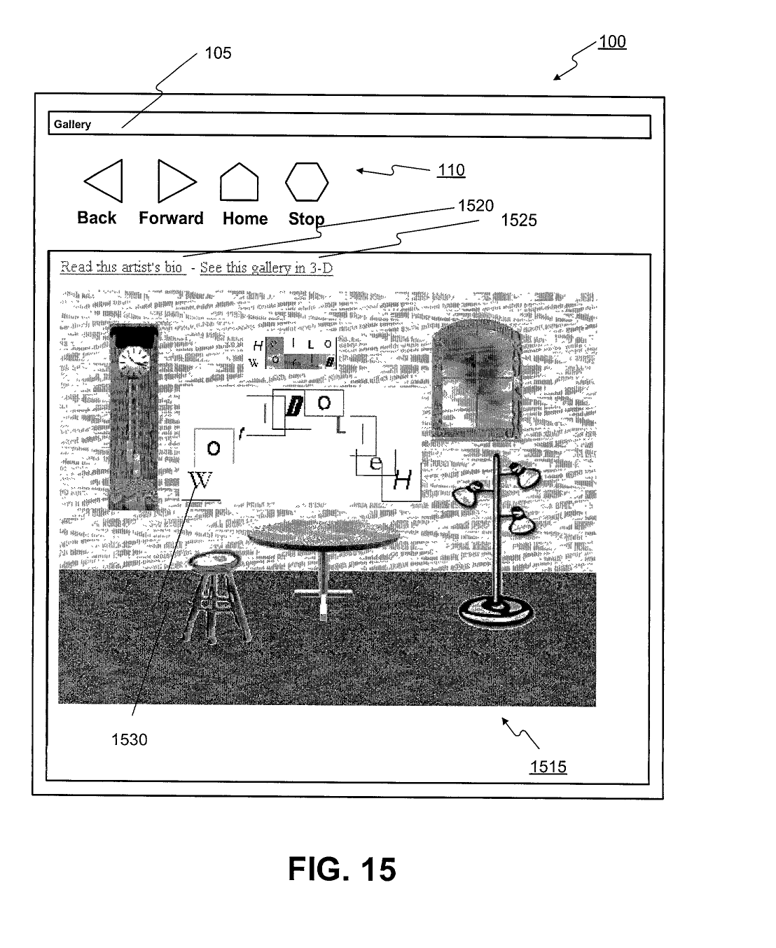

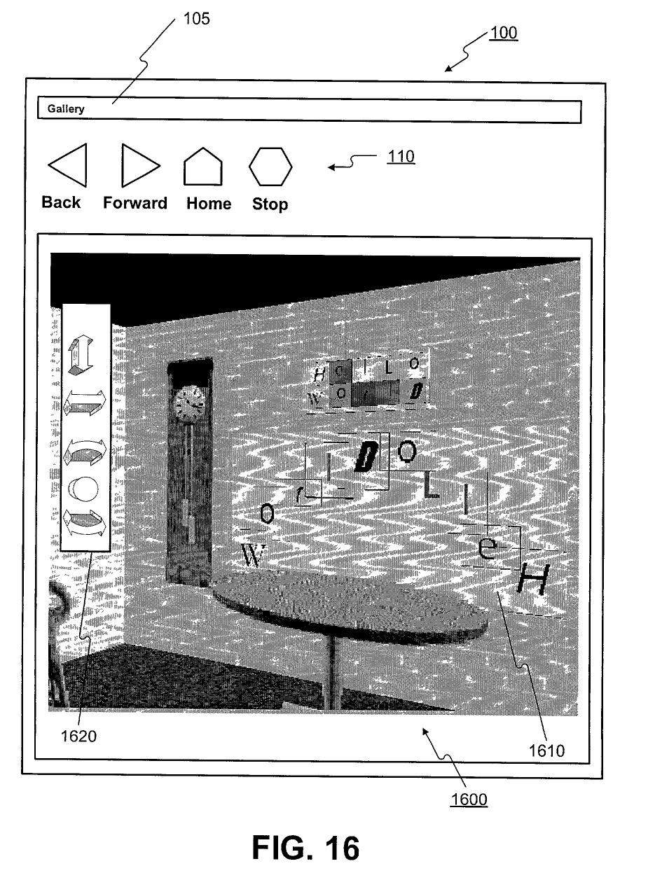

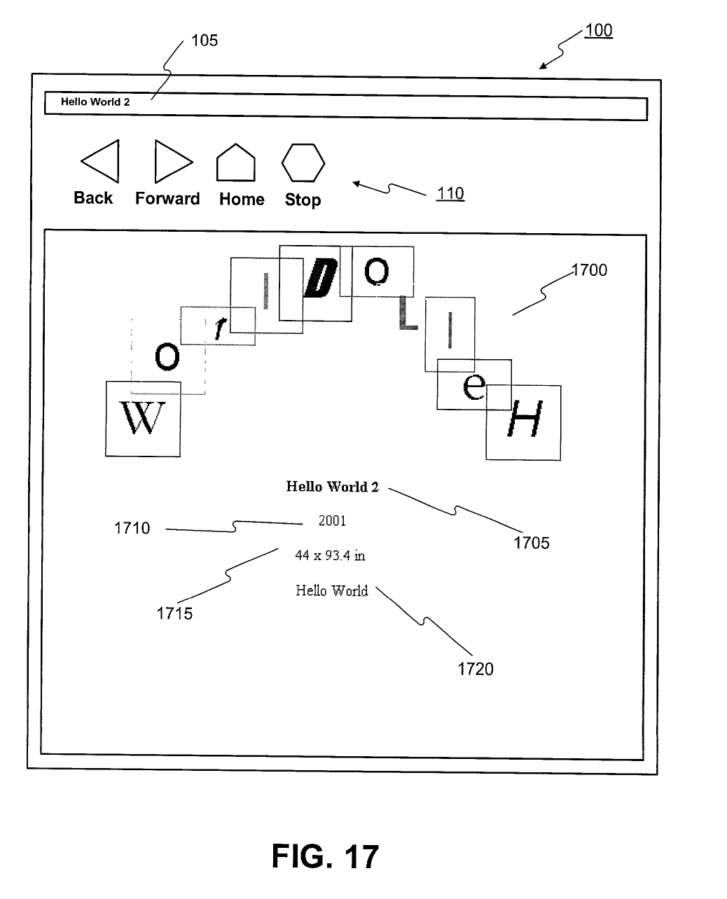

Upon selecting link 1525 in conventional web browser 100, as depicted in FIG. 15, a properly enabled browser may display the same gallery environment in VRML (ver. 2). A view of such a display is depicted in FIG. 16. Conventional VRML controls 1620 may allow the user to roll the gallery environment, “fly” up or down, or spin the gallery to obtain a 360-degree view. Furthermore, the VRML display may also include embedded links to the artwork. For example clicking on region 1610 may preferably link to the page depicted in FIG. 17, which provides a view of artwork of a second size, its title 1702, year 1710, size 1715, and description 1720.

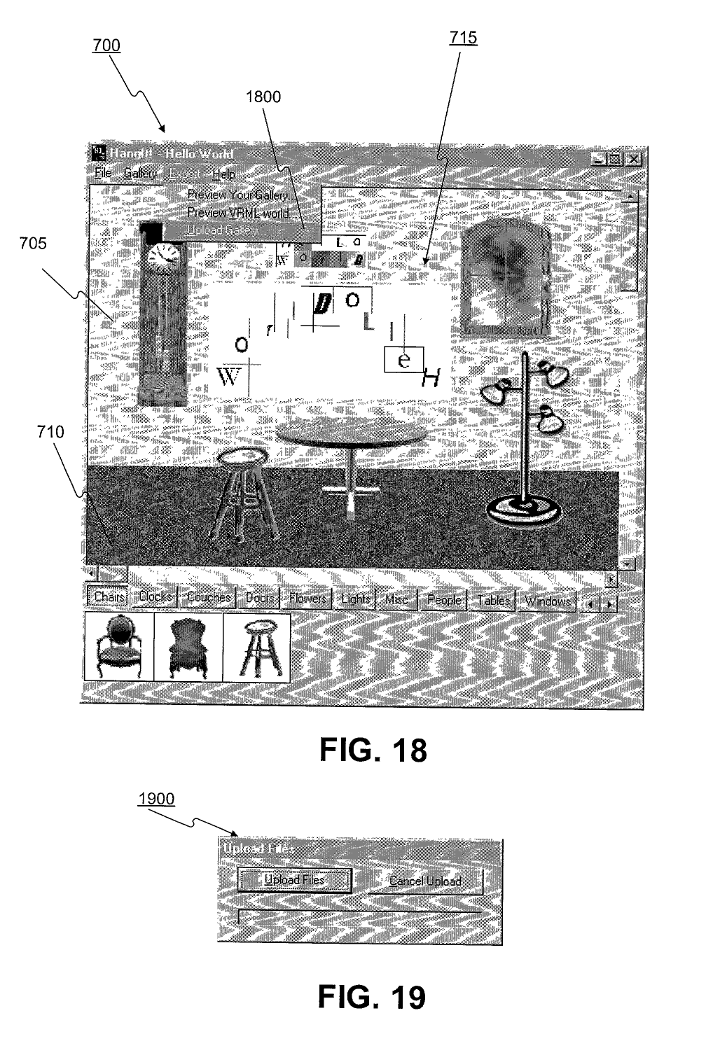

If the gallery account user is satisfied with gallery environment 715 and the associated details, then the gallery account user may then upload the gallery account information to host system 350. FIG. 18 depicts drag-and-drop interface 700 with menu option 1800 for uploading the gallery account information to host system 350 through network 310. FIG. 19 depicts an exemplary dialog box 1900 by which a gallery account user may manage the process of uploading gallery account information.

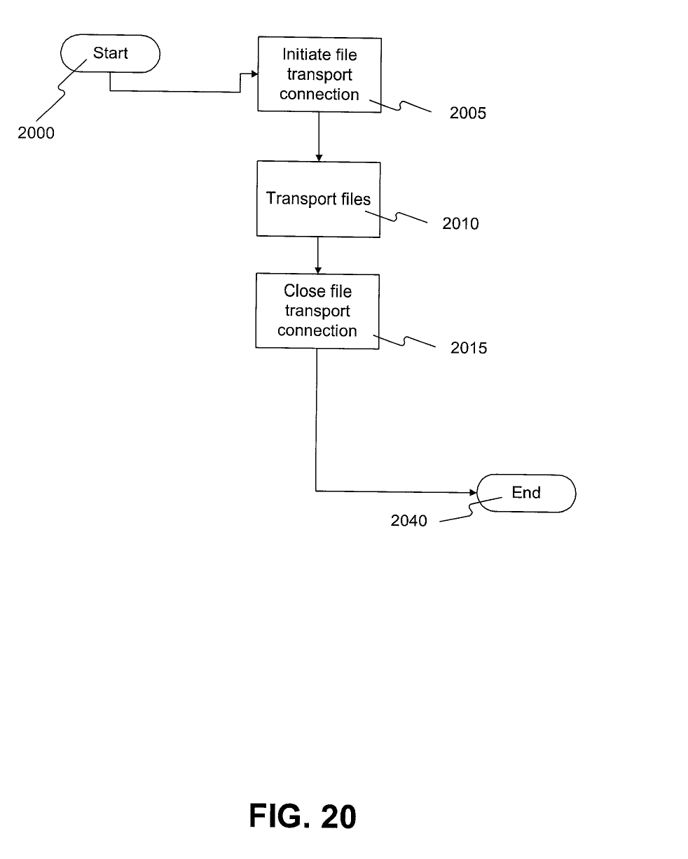

Furthermore, FIG. 20 depicts a flow chart consistent with the present invention for uploading gallery account information. For exemplary purposes only, step 2005 depicts the initiation of a file transport connection between the local terminal 300 and the host system 350. In a preferred embodiment, the file transport connection is an FTP (file transfer protocol) connection. However, one skilled in the art will appreciate that a variety of file transfer schemes may be used in order to transfer files between local terminal 300 and host system 350 such as “http,” gopher, or other conventional schemes. Step 2010 depicts the transfer of data or files between the local terminal 300 and the host system 350. Step 2015 depicts the closing of the file transport connection. One skilled in the will further appreciate that a program or applet running in a web browser environment may also be configured to transfer files between local terminal 300 and host system 350 using a conventional scheme such as FTP.

B. Conclusion

The foregoing description of an implementation of the invention has been presented for purposes of illustration and description. It is not exhaustive and does not limit the invention to the precise form disclosed. Modifications and variations are possible in light of the above teachings or may be acquired from practicing of the invention. For example, the described implementation includes software but the present invention may be implemented as a combination of hardware and software or in hardware alone.

Furthermore, although aspects of the present invention are described as being stored in memory, one skilled in the art will appreciate that these aspects may also be stored on or read from other computer-readable media, such as secondary storage devices, like hard disks, floppy disks, or CD-Rom; a carrier wave from the Internet; or other forms of RAM or ROM.

Further still, although aspects of the present invention are described as implemented through a program running in the operating environment or system of a conventional PC, one skilled in the art will appreciate that these aspects or others may also be implemented through programs or applets running in the operating environment of a web browser. The scope of the invention is defined by the claims and their equivalents.

What is claimed is:

1. A method for hosting a virtual art gallery on a network comprising the steps of:
providing, on a network, a host system configured with a plurality of gallery accounts including at least a first gallery account,
receiving, through the network at the host system, a request for read-only access to the first gallery account by a first user; and
providing, on the network to the first user, the first gallery account in a read-only access mode;
where each of the plurality of gallery accounts has a gallery item limit, gallery personal information, gallery qualification information, a gallery environment, and at least a first gallery item, and where each of the plurality of gallery accounts is characterized by at least two access modes including the read-only access mode and a qualified access mode;
where each of the gallery items is characterized by at least a virtual size; and
where the first gallery account in the read-only access mode is configured to allow access to at least two representations of the first gallery item and the gallery environment including a two-dimensional representation and a virtual reality representation.

2. The method claim 1 further comprising:
receiving, on the network at the host system, a request for qualified access to the first gallery account by a second user; and
providing, on the network to the second user, the first gallery account in the qualified access mode;
where the first gallery account in the qualified access mode is configured to allow the second user to modify the associated gallery personal information, the associated gallery qualification information, to add a second gallery item, and to remove the first gallery item.

3. A system for hosting a virtual art gallery on a network comprising:
a host system on the network configured with a plurality of gallery accounts including at least a first gallery account,
where each of the plurality of gallery accounts has a gallery item limit, gallery personal information, gallery qualification information, a gallery environment, and at least a first gallery item, and where each of the plurality of gallery accounts is characterized by at least two access modes including the read-only access mode and a qualified access mode; and
a first local terminal configured for a first user to access the first gallery account on the host system over the network in read-only access mode,
where each of the gallery items is characterized by at least a virtual size; and
where the first gallery account in the read-only access mode is configured to allow access to at least two representations of the first gallery item and the gallery environment including a two-dimensional representation and a virtual reality representation.

4. The system of claim 3 further comprising:
a second terminal configured for a second user to access the first gallery account on the host system over the network in qualified access mode,
where the first gallery account in the qualified access mode is configured to allow the second user to modify the associated gallery personal information, the associated gallery qualification information, to add a second gallery item, and to remove the first gallery item.
